(19) United States
(12) Patent Application Publication
(10) Pub. No.: US 2015/0329777 A1
(43) Pub. Date: Nov. 19, 2015

(54) POLYCRYSTALLINE CERAMICS, THEIR PREPARATION AND USES

(71) Applicant: Schott AG, Mainz (DE)

(72) Inventors: Bernd Hoppe, Ingelheim (DE); Peter Nab, Mainz (DE); Volker Hagemann, Klein-Winternheim (DE); Yvonne Menke, Mainz (DE); Wlofram Beier, Essenheim (DE)

(21) Appl. No.: 14/809,309

(22) Filed: Jul. 27, 2015

Related U.S. Application Data
(63) Continuation of application No. PCT/EP2014/051512, filed on Jan. 24, 2014.

(30) Foreign Application Priority Data
Jan. 28, 2013 (DE) 10 2013 100 821.6

(51) Int. Cl. C09K 11/77; C04B 38/06

(52) U.S. Cl. CPC C09K 11/7774; C04B 38/06

(57) ABSTRACT

Polycrystalline ceramics with specifically adjusted scattering power are provided, as well as methods for the preparation of such ceramics and uses thereof. The polycrystalline ceramic include an optoceramic phase and a pore phase, wherein the polycrystalline ceramic has a remission of at least 70% at a wave length of 600 nm and a sample thickness of 1 mm.

### CROSS REFERENCE TO RELATED APPLICATIONS

This application is a continuation of International Application Serial No. PCT/EP2014/051512 filed Jan. 24, 2014, which claims benefit under 35 U.S.C. §119(a) of German Patent Application No. 10 2013 100 821.6 filed Jan. 28, 2013, the entire contents of both which are incorporated herein by reference.

### BACKGROUND

1. Field of the Invention

The subject matter of the present invention are polycrystalline ceramics with specifically adjusted scattering power. To this end the polycrystalline ceramic comprises an optoceramic phase and a pore phase. A method for the preparation of such ceramics and their uses are also according to the present invention.

2. Description of Related Art

Preferably, the polycrystalline ceramics are used as converters. A converter is suitable for absorbing light of a particular wave length and emitting light of another wave length.

In prior art ceramic converters are generally known. But conventional converter materials do not comprise pore phases. Because an aim of the optimization of the preparation methods was that the ceramics do not have pores. Furthermore, converters which are known from prior art are normally intended for use in transmission operation and are constructed accordingly. However the converter materials according to the present invention are intended for use in remission operation.

Transparent ceramics are broadly known from a series of uses. Translucent hexagonal Al₂O₃ is used for the production of discharge bodies for high pressure discharge lamps. Also Sc₂O₃ and Y₂O₃ are used. Eu-doped (Y,Gd)₂O₃, Pr:Ce:Gd₂O₂S, Ce-doped lutetium aluminum garnet (LuAG) and doped pyrochlores are known as scintillation material for CT devices. Aluminum oxynitrides, spinel and nanoscale Al₂O₃ are used as extremely strong materials as antiballistic protection media. Y₂O₃ serves as a medium with IR transmission in the range of VIS to mid IR as well as for chemically resistant windows in coating facilities.

Transparent rare earths-doped yttrium aluminum garnet (YAG) ceramics are used e.g. as laser rods or in the case of cerium doping as converter material.

Generally, for the preparation of highly transparent ceramics two prerequisites have to be fulfilled. On the one hand, by the suitable choice of powder and in connection with the process control (powder preparation, molding, sintering, optionally hot isostatic pressing) a pore-free structure has to be prepared. Otherwise a light beam may be scattered at the pores which are present in the grain boundary area or within the grain. Also in the grain boundary area no second phases which have been created in an uncontrolled manner are allowed to be positioned there. Sintering aids which are optionally used ideally are inserted into the merely single phase mixed-crystal structure as components.

On the other hand, uses of translucent ceramics are known, in which cases scattering should be adjusted intentionally. In the case of CT scanners on a distance which is as short as possible (few mm) as much as possible highly energetic excitation radiation has to be absorbed.

In the case of converters for LEDs there is yet a greater demand for high absorption on a short distance. LED converter materials are active media which directly absorb the radiation of the LED light source having relative low wave length (primary radiation) or partially absorb it over a plurality of intermediate steps, wherein electron-hole pairs are created. Their recombination results in excitation of a near activator center. In this case the latter is energized into an excited meta-stable state. Its relaxation according to the choice of the activator results in emission of light with longer wave length (secondary radiation). Since the emitted light is of lower energy than the exciting light, this conversion is also referred to as “down conversion”. In addition, a fraction of the non-absorbed primary radiation passes the converter, wherein primary and secondary radiation in turn result in a shade which differs from that of the primary radiation.

For purposes of illumination most often a blue LED is combined with a yellow illuminant which most often is cerium-doped powder of yttrium aluminum garnet. White light is created by mixture of partially transmitted blue light and yellow fluorescent radiation. In this case, a suitable ceramic converter, e.g. a Ce:YAG converter, has to be capable of absorbing blue radiation of an exciting blue LED as strong as possible on a distance of <1 mm, ideally <0.5 mm and on the other hand emitting the emitted radiation in forward direction (low remission). In these cases a suitable tailoring of absorption, emission and remission through the material structure or the material composition is required.

In addition, of extraordinary importance for converter materials are in particular the aspects of high quantum yield, high Stokes efficiency, high absorption efficiency and high light yield. Furthermore, it must be possible to prepare the material in an economic manner.

In prior art ceramic converter materials for LED consisting of at least two phases are known. US 2006/0124951 A1, US 2006/0250069 A1 and EP 1 980 606 A1 disclose ceramics of at least two phases, e.g. Al₂O₃ and Ce:YAG for the white light conversion from blue LED light. The preparation is conducted via an incidental crystallisation of a YAG melt which has been specifically enriched with Al₂O₃. Finally, the Al₂O₃ grains are arranged between the Ce:YAG in an embedded manner. But this melting process is not suitable for the specific and reproducible adjustment of a grain structure. The converter materials described in prior art are prepared such that absence of pores is achieved. Therefore, the converters do not comprise a pore phase.

In U.S. Pat. No. 4,174,973 ceramics consisting of yttria as well as 0.1-5 wt % MgO and/or MgAl₂O₄ are disclosed. The MgO containing compounds have the effect of a sintering aid and the sintering itself is conducted at very high temperatures of above 1850° C., preferably at 2100° C. At this temperature for example MgO can be inserted into the yttria lattice, thus a mixed system is present. However during cooling below the subsolidus separation into MgO and yttria takes place. Probably, the mixed two phase system is responsible for the reduced transmission of the material, since the two phases have different refractive indices. Instructions how a mixed system with specifically controlled structure can be created are not given. U.S. Pat. No. 4,174,973 describes the absence of pores as an advantage of the developed converter material.

Also the provision of an optoceramic converter is known. So US 2004/0145308 A1 describes an LED with at least one polycrystalline converter being in the range of the blue excitation source. However, the single converters are single-phase. In US 2004/0145308 A1 it is mentioned that it is possible that pores are present, but the size, geometry and volume of which are not characterized. Furthermore, the detailed preparation of a converter material with pores is not described. In the case of these described materials the pores are mainly concentrated near the surface of the material.

None of the prior art ceramics is designed such that it is suitable for use in remission operation, in particular as a converter of a laser diode.

### SUMMARY

Therefore, it is an object of this invention to provide ceramics which can be prepared such that the extent of scattering can be specifically adjusted. A further object of the invention is the provision of ceramics which are stable in the case of excitation with a laser diode, i.e. which are still functioning also at temperatures of >180° C. Furthermore, it should be possible to prepare these ceramics for a reasonable price.

The object of the present invention is solved by the subject matter of the present application. The object is solved by a polycrystalline ceramic comprising at least one pore phase and at least one optoceramic phase, preferably consisting thereof. Also a converter comprising this ceramic or consisting thereof as well as the use of the ceramic as a converter, preferably in remission and in particular in laser diodes are according to the present invention.

The optoceramic phase is crystalline; it preferably consists of densely arranged crystallites. In particular, the optoceramic phase has densities, based on the theoretical density of the respective material, of preferably at least 85%, further preferably at least 90%. In particular, the optoceramic phase has densities, based on the theoretical density of the respective material, of at most 99%, further preferably at most 97%, further preferably at most 95%.

The pore phase comprises scattering centres with specifically adjusted size, volume and geometry. The fraction of the pore phase is at least 1 vol %, preferably at least 2.5 vol %, further preferably at least 5 vol % and particularly preferably at least 10 vol % of the polycrystalline ceramic of this invention. When the fraction of the pore phase is lower, then the desired scattering cannot be achieved.

The fraction of the pore phase of the polycrystalline ceramic should preferably not exceed 50 vol %, further preferably 40 vol % and particularly preferably 30 vol %. With the incorporation of an advantageous fraction of a pore phase into the ceramic important properties of the material, such as the remission, can be controlled, while highest optical quality is guaranteed.

Surprisingly, the ceramics according to the present invention are thermally stable in spite of the pore phase. Heat which is accumulated in the pores can be transported through the grain boundaries and the ceramic grains to the outside thereof without cracking of the ceramics. Therefore, the ceramics are also suitable for use at high temperatures.

The polycrystalline ceramics of this invention are in particular suitable for uses, for which scattering is required, such as in particular in the case of converters for laser diodes. In particular, the ceramics according to the present invention are also suitable for uses at high temperatures which for example may be present in the case of converters for LD in the remission structure. Also in the case of medical imaging, in particular in CT devices, the materials of this invention can be used. Therefore, also an illuminant comprising the polycrystalline ceramic of this invention is according to the present invention. Furthermore, a CT scanner comprising the polycrystalline ceramic of this invention is according to the present invention.

The optoceramic phase comprises crystallites which preferably have a cubic crystal structure. Preferably, the optoceramic phase consists of these crystallites. The crystallites may be selected from garnets, cubic sesquioxides, spinels, perovskites, pyrochlores, fluorites, oxynitrides and mixed crystals of two or more of the mentioned materials. The crystallites may also have non-cubic structure. Preferably, the crystallites are oxidic.

The crystallites have preferably a diameter of at most 50 μm, further preferably at most 20 μm, yet further preferably at most 10 μm, yet further preferably at most 8 μm, yet further preferably at most 7.5 μm, yet further preferably at most 5 μm, particularly preferably at most 3 μm. The optical properties of the optoceramic phase are negatively affected if the crystallites are too large. The crystallites have preferably a diameter of at least 0.2 μm, further preferably at least 0.5 μm, yet further preferably at least 1 μm, yet further preferably at least 2 μm, particularly preferably at least 2.5 μm. The optoceramic phase is not stable enough if the crystallites are too small. The indicated diameters are Martin's diameters. The diameter is preferably determined by microscopic methods, particularly by light microscopy.

Preferably, the crystallites have the chemical empirical formula AₓB_{y}O_{z} with x≧1 and y≧0 and x+y=2/3z. In this case A is preferably selected from the scandium group or from the lanthanoids. B is preferably selected from the boron group. Further preferably, A is selected from the group comprising yttrium, scandium, gadolinium, ytterbium, lutetium and mixtures thereof. B is preferably selected from aluminum, gallium and mixtures thereof. Yet further preferably, A is yttrium and B is aluminum with x=3 and y=5. A may also be a mixture of the mentioned elements, e.g. Y and Gd or Y and Lu. B may also be a mixture of the mentioned elements, i.e. Al and Ga.

Also crystallites with a composition of the chemical empirical formula AₓB_{y}C_{w}O_{z} with x,y,w≧1 and x+y+w=2/3z are a possible embodiment of the present invention.

The crystallites of an alternative embodiment of the present invention have a chemical composition of the form AₓB_{y}O_{z} with x,y≧1 and y=2x and x+y=3/4z. In this embodiment A is preferably selected from the group of alkaline-earth metals or from the zinc group and B is preferably selected from the boron group. Particularly preferably, A is magnesium or zinc and B is aluminum.

Preferable garnets are yttrium aluminum garnet (YAG), yttrium gadolinium aluminum garnet (YGAG), gadolinium gallium garnet (GGG), lutetium aluminum garnet (LuAG), lutetium aluminum gallium garnet (LuAGG), yttrium scandium aluminum garnet (YSAG) and mixtures thereof.

Preferable cubic sesquioxides are Y₂O₃, Gd₂O₃, Sc₂O₃, Lu₂O₃, Yb₂O₃ and mixtures thereof. Preferable oxynitrides are AlON, BaSiON, SrSiON and mixtures thereof. Preferable spinels are ZnAl₂O₄, MgAl₂O₄ and their mixed phases.

In an alternative embodiment the crystallites of the optoceramic phase have a non-cubic crystal structure. Preferable are non-cubic sesquioxides such as in particular Gd₂O₃, La₂O₃, Al₂O₃, Lu₂Si₂O₇ and mixtures thereof.

The optoceramic phase may comprise one or more optically active centers. The active centers are preferably selected from the group consisting of rare earth ions and transition metal ions. Preferably, the active centers are selected from the group of rare earth ions. Particularly preferable are the ions of the following elements: Ce, Cr, Eu, Nd, Tb, Er, Pr, Sm and mixtures thereof. Further preferable are Ce, Cr, Eu, Tb, Pr, Sm and mixtures thereof. A particularly preferable active center is Ce. The active center serves for the conversion of incident radiation of one wave length into radiation of another wave length.

Preferably, the optoceramic phase comprises the active center in a mass fraction of at least 0.01 wt %, further preferably at least 0.03 wt % and particularly preferably at least 0.045 wt %. Preferably, the active center should be present in a fraction of not higher than 1 wt %, further preferably not higher than 0.7 wt % and particularly preferably not higher than 0.55 wt %. When these values are satisfied, then a superior conversion can be achieved.

The optoceramic phase may be translucent or transparent. Preferably, the optoceramic phase is transparent for visible light.

In the sense of this invention a ceramic or a phase is “transparent for visible light”, when it has an internal transmittance which in a 50 nm broad range within the spectrum of visible light (of 380 nm to 800 nm) is higher than 25%. This internal transmittance of the optoceramic phase is preferably even higher than 60%, further preferably higher than 80%, further preferably higher than 90% and particularly preferably higher than 95%. In this case the internal transmittance at a layer thickness of 2 mm is meant.

The pore phase comprises at least one scattering centre and is embedded into the optoceramic phase. Preferably, the pore phase comprises a plurality of scattering centres which are embedded into the optoceramic phase. A “scattering centres” in the sense of the present invention preferably means a pore. Preferably, the pores have sizes of 0.1 to 100 μm, further preferably 0.5 to 50 μm and particularly preferably 3 to 5 μm.

Preferably, the ceramic according to the present invention comprises pores with a surface area fraction in cross-section of at least 1%, more preferably at least 3% and even more preferably at least 4%. Preferably, the ceramic according to the present invention comprises pores with a surface area fraction in cross-section of at most 25%, more preferably at most 15% and even more preferably at most 10%. When the pore fraction is too high, then the stability of the ceramic is not high enough and the desired remission values cannot be achieved.

According to the present invention the pores have geometries which are selected from spherical pores, ovoid pores and oblong pores. Preferably, the pores have geometries which are selected from ovoid pores and oblong pores. Ovoid pores are particularly preferred. The desired scattering can be achieved particularly well with ovoid pores.

In this case the pore size, pore volume and pore geometry are specifically adjusted via the preparation process and the pore phase formers used. On the one hand, an increase of the sintering temperature positively correlates with the size of the pores. On the other hand, the pores also vary in size and form according to the pore phase former used. Here spherical, ovoid and oblong pores can be distinguished.

The ratio of the maximum diameter to the minimum diameter of one pore of the spherical pores each is in the range of 1:1 to 1.09:1. The ratio of the maximum diameter to the minimum diameter of the ovoid pores is in the range of 1.1:1 to 2.9:1. The ratio of the maximum diameter to the minimum diameter of the oblong pores is in the range of 3:1 to 15:1. Particularly preferable are ovoid pores with a ratio of 2.5:1. For the determination of the mentioned ratio it is defined that the maximum diameter is the largest diameter of a pore and that the minimum diameter is the smallest diameter of the same pore.

Both, the ovoid pores and the oblong pores can vary in size according to the special embodiment of the present invention. Large ovoid pores have a maximum diameter of 20-50 μm and a minimum diameter of 10-20 μm. Small ovoid pores have a maximum diameter of 2-6 μm and a minimum diameter of 1-3 μm. Large oblong pores have a maximum diameter of 20-50 μm and a minimum diameter of 2-8 μm. Small oblong pores have a maximum diameter of 5-15 μm and a minimum diameter of 1-5 μm.

In particular, a preferable embodiment of the present invention contains pores having a maximum diameter of <10 μm. Pores which are too big reduce the quantum yield of the conversion process, because then the converted light is entrapped therein.

Besides the pore size also the number of the pores per unit volume can be adjusted according to the present invention. A reduction of the number of pores per unit volume may in particular be achieved by an increase of the concentration of the sintering aid and/or the addition of a pore phase former.

Preferably, the density of the ceramic is at least 80%, further preferably at least 85%, further preferably at least 90%, yet further preferably at least 93% of the theoretical density. Preferably, the density of the ceramic is at most 96.5%, further preferably 95.5% of the theoretical density. According to the present invention the density of the ceramic is adjusted through the kind and the concentration of the pore phase former and/or the concentration of the sintering aid. The density of the ceramic can also be influenced via the sintering temperature and/or the heating rate. More dense ceramics are obtained by high heating rates. Higher scattering can be obtained with ceramics of lower density.

The heating rate is preferably at least 0.5 K/min, further preferably at least 1 K/min, yet further preferably at least 2 K/min, particularly preferably at least 4 K/min. However, the heating rate should also not be chosen too high. Otherwise, thermal tensions may increasingly occur. Moreover, too dense ceramics may be obtained. The heating rate is preferably at most 50 K/min, further preferably at most 20 K/min, yet further preferably at most 10 K/min, particularly preferably at most 5 K/min.

The pores are formed by the specific addition of pore phase formers during the preparation process.

It has been found that plastics, particularly thermoplastics, are not as well suited as pore phase formers according to the present invention compared to saccharides. Particularly polyacrylate, polystyrene, polymethylmethacrylate, polyethylene, polytetrafluoroethylene, polypropylene, polyamide, polyethylene terephthalate, polyvinyl chloride and polycarbonate are preferably not used as pore phase formers.

Preferably, the pore phase formers comprise natural or synthetic saccharides. Particularly preferably, the pore phase formers consist of natural or synthetic saccharides. Further particularly preferably, the pore phase formers consist of natural saccharides. Preferably, the pore phase formers are selected from mono, di or polysaccharides, particularly from sugars or starch. According to the present invention also mixtures of different saccharides can be used as pore phase formers. A preferred pore phase former is for example powdered sugar. Preferred powdered sugar contains in addition to the disaccharide approximately 1 to 10 wt.-% of corn starch. Particularly preferred powdered sugar contains in addition to the disaccharide approximately 3 wt.-% corn starch.

If natural pore phase formers are used, the sintering behavior of the ceramic material itself is preferably not affected. Thus, preferably the course of the sintering is the same with or without the pore phase formers. This is an advantage of the natural pore phase formers in comparison to the synthetic pore phase formers.

Preferably, the monosaccharides are selected from fructose, glucose, mannose and galactose. Particularly preferable monosaccharides are glucose and fructose. Disaccharides are preferably selected from lactose, maltose and sucrose. Disaccharides are readily soluble in water, poorly soluble in ethanol and insoluble in most organic solvents. Since the mixtures for the preparation of converter ceramics are preferably prepared in alcoholic solution, disaccharides are particularly suitable as pore phase formers. A particularly preferable disaccharide is sucrose. Preferable polysaccharides consist of more than 10 units of monosaccharides. Pentoses and hexoses have shown to be suitable units of monosaccharides, further preferably being selected from glucose, galactose, xylose, fructose, arabinose, mannose, mannuronic acid, guluronic acid, gulose and mixtures thereof. Preferably, the polysaccharides are polycondensates of glucose monomers. Further preferably, the glucose monomers are bonded through α-1,4 and/or α-1,6 glycosidic bonds, wherein particularly preferably the polysaccharides have the general formula (C₆H₁₀O₅)ₙ. Preferably, the molar mass of the polysaccharides is >10⁵ g/mol. Preferably, the polysaccharides are selected from potato starch, potato flour, rice starch, corn starch, wheat starch and mixtures thereof, further preferably they are selected from rice starch, corn starch, wheat starch and mixtures thereof. Rice starch is particularly preferable as a pore phase former. Rice starch creates the most homogenous distribution of pores.

Preferably, the particle size of the polysaccharides is less than 200 μm. Further preferably, the particle size of the polysaccharides is less than 185 μm, further preferably less than 180 μm. Preferably, the particle size is determined by light microscopy, wherein in this case Martin's diameter is determined.

Under heat exposure starch can physically bind an amount of water which is a multiple amount of the weight of the starch itself, can swell up and gelatinize. During heating in the presence of water starch swells up at a temperature of 47-57° C., the layers burst, and at a temperature of 55-87° C. (potato starch at 62.5° C., wheat starch at 67.5° C.) a starch paste is created which according to the starch grade has different stiffening capability. The stiffening capability of corn starch paste is higher than that of wheat starch paste. And the stiffening capability of the wheat starch paste is higher than that of potato starch paste. According to the starch grade the starch paste decomposes under acidic conditions more or less easily. With a suitable choice of the pore phase former the geometry and the homogeneity of the distribution of the pores can be adjusted.

For creating spherical pores, preferably potato flour, potato starch or mixtures thereof are used. For obtaining oval pores, preferably rice starch is used. For achieving oblong pores, preferably corn starch is used.

If disaccharides and/or polysaccharides are used as pore phase formers, ceramics with lower density can be obtained in comparison to ceramics, for production of which monosaccharides have been used as pore phase formers. A lower density usually correlates with higher scattering. Thus, using disaccharides and/or polysaccharides as pore phase formers, ceramics may be obtained with which higher scattering may be achieved.

On the other hand, monosaccharides may usually be better burnt out of the ceramics compared to disaccharides and polysaccharides. Remainders of carbon, which may potentially remain in the ceramics after burning out, may negatively affect the quantum yield. Therefore, using monosaccharides as pore phase formers, ceramics with higher quantum yield may be obtained compared to ceramics, for production of which disaccharides and/or polysaccharides have been used as pore phase formers.

In a preferable embodiment of the present invention the pore phase is homogenously embedded in the optoceramic phase. An inhomogeneous distribution of the pores reduces the quantum yield of the conversion process. According to the pore phase former used the homogeneity of the distribution of the pores can be adjusted specifically. The use of potato starch as a pore phase former rather results in an inhomogeneous distribution of the pores. The use of wheat starch as a pore phase former results in a more homogenous distribution of the pores within the sintered body. The most homogenous distribution of the pores can be achieved with the use of rice starch as a pore phase former. The homogeneity of the distribution of the pores is determined with the help of scanning electron microscopy.

The high quantum yield being preferable for converter materials is achieved by the preferably cubic crystal structure of the optoceramic phase and the transparency which results from that. A further approach for keeping the quantum yield high is the preparation method according to the present invention and the presence of pores in the polycrystalline ceramic according to the present invention. In this case, the quantum yield in the sense of the present invention is the ratio of the number of emitted photons (light quantums) to the number of absorbed photons. Preferably, the quantum yield of the polycrystalline ceramics according to the present invention is higher than 60%, further preferably higher than 70%, yet further preferably higher than 80%, yet further preferably higher than 85%, yet further preferably higher than 88% and particularly preferably higher than 90%. The quantum yield is particularly high, when monosaccharides are used as pore phase formers.

Preferably, the polycrystalline ceramic has a remission of 70 to 100%, preferably 75 to 95%, particularly preferably 75 to 90% at a wave length of 600 nm and a sample thickness of 1 mm. Polycrystalline ceramics having such remissions are particularly suitable as converters in backscattering mode, in particular as HBLED and LD converters.

The remission can be measured in a spectral photometer with an integration sphere, advantageously involving the Fresnel reflex. In this case sample thicknesses of 1 mm have been shown to be advantageous. The remission at 600 nm is a measure for the scattering of the material. The evaluation of the scattering should be carried out outside the excitation spectrum, but if possible inside the emission spectrum. The choice of the evaluation wave length of 600 nm fulfills this condition. The higher the scattering, the stronger is the remission of the material at 600 nm.

Due to the use of saccharides as pore phase formers, the blue-remission may be increased in comparison to ceramics, for production of which no pore phase formers have been used.

The object of the present invention is further solved by a method for the preparation of polycrystalline ceramics according to the present invention. This method preferably comprises the following steps: providing a mixture of the starting materials of the optoceramic phase; adding of pore phase formers comprising at least one saccharide and optionally sintering aids to the mixture; preparing of a molded body from the mixture; and sintering the molded body.

In a preferable embodiment the molded body is presintered in addition, preferably at temperatures of between 500 and 1200° C. The advantage of this measure is that the carbonates escaping from the pore phase formers are completely burnt out from the green body. Residual carbonates compromise the efficiency of the conversion. Most preferably, the removal of the binder is conducted under a gas stream, wherein the gas is preferably selected from oxygen, forming gas, argon, nitrogen and mixtures thereof. Oxygen is particularly preferable, because reduced constituents may be oxidized again.

Preferably, the mixture of the starting materials also contains the optically active constituent. In this way, a particularly uniform doping is achieved. Furthermore, laborious subsequent doping methods, as for example the “dip coating method”, may be avoided.

Powders of primary particles having diameters of <1 μm, preferably with a size in the nanometer range (<300 nm), particularly preferably with primary particle diameters of from 50 to 250 nm, are weighed out in the ratio according to the target composition. The indicated diameters are preferably determined via dynamic light scattering. The target composition may vary around the stoichiometric range of the garnet composition, i.e. may either be in a range which differs from the composition of the Y₂O₃ rich and/or Gd₂O₃ rich side in an amount of about 0.01-10 mol % or in a range which differs from the composition of the Al₂O₃ rich and/or Al₂O₃-Ga₂O₃ rich side in an amount of about 0.01-10 mol %. After the addition of dispersants and binders the mixture is preferably mixed with ethanol. Preferably, this is conducted with Al₂O₃ balls in a ball mill and particularly preferably for 12 to 16 h. Prior to an optional second mixing step in a tumbling mixer for preferably 10 to 24 h, there is a choice of adding a sintering aid and/or a pore phase former to the mixture.

Preferably, the sintering aid is selected from TEOS, colloidal SiO₂, SiO₂ nanopowder, SiO₂ μm-powder and CaCO₃. A particularly preferable sintering aid is TEOS. TEOS is preferably used in concentrations of 0 to 1 wt %, particularly preferably in concentrations of 0.1 to 0.5 wt %. TEOS is used for the optimum adjustment of the pore number.

For the milled suspension there is a choice of drying in a rotary evaporator or granulating in a spray dryer.

Subsequently, the powder is preferably uniaxially molded into discs or rods. Preferably, the uniaxial pressure conditions are between 10 and 50 MPa, and preferably, the pressure times are few seconds to 1 min. Preferably, the preformed molded body is further compacted in a cold isostatic press, wherein preferably the pressing pressure is between 100 and 300 MPa. Preferably, the medium for pressure transfer is water or oil.

Subsequently, preferably in a first thermal step optionally a binder is burnt out. Preferably, the tempering time is 1 to 24 h. Preferably, the temperature is between 600 and 1000° C. Subsequently, preferably, the burnt out green body is sintered in a chamber kiln, preferably under an oxygen stream, alternatively also directly in air, nitrogen, argon or helium or in a vacuum sintering kiln (in particular under reduced pressure: 10⁻⁵-10⁻⁶ mbar). The sintering temperatures and times depend on the sintering behavior of the mixture, i.e. after the formation of the composition the further compaction into a ceramic with defined specifically adjusted pores is conducted. In the case of Ce:Y₃Al₅O₁₂ the garnet phase is formed starting at a temperature of ca. 1350 to 1450° C. The sintering into a ceramic body is effected at higher temperatures, preferably between 1550 and 1800° C. for 2 to 24 h.

According to the chemistry and the sensitivity of the system for reduction after the sintering step the sample may again be reoxidized in a further thermal step (e.g. 1000° C., 5 hours, O₂ stream). Preferably, optically translucent and homogenous bodies are prepared which can be processed into converter materials.

Preferably, the volume fraction of the pore phase formers of the mixture is at least 1%, further preferably at least 2.5% and more preferably at least 10%. Preferably, the fraction of the pore phase formers should not exceed a value of 50 vol %. When the volume fraction is too low, then the desired remission cannot be achieved. In the case that the volume fraction is too high, the mechanical stability is compromised.

The preparation method according to the present invention allows the preparation of a polycrystalline ceramic with an optoceramic phase and a pore phase. With the specific choice of the pore phase formers and the volume fraction of the pore phase the remission properties of the polycrystalline ceramic can specifically be adjusted.

When the conditions of the above described preparation method are fulfilled, then polycrystalline ceramics according to the present invention having the mentioned superior properties are obtained.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the influence of different pore phase formers as well as the influence of the heating rate on the density of the ceramic.

FIG. 2 shows that the sintering behavior of Ce:YAG is not changed by addition of monosaccharide or disaccharide and 3 wt.-% polysaccharide as pore phase formers.

FIG. 3 shows the influence of different pore phase formers on the quantum yield and on the blue-remission.

### DETAILED DESCRIPTION

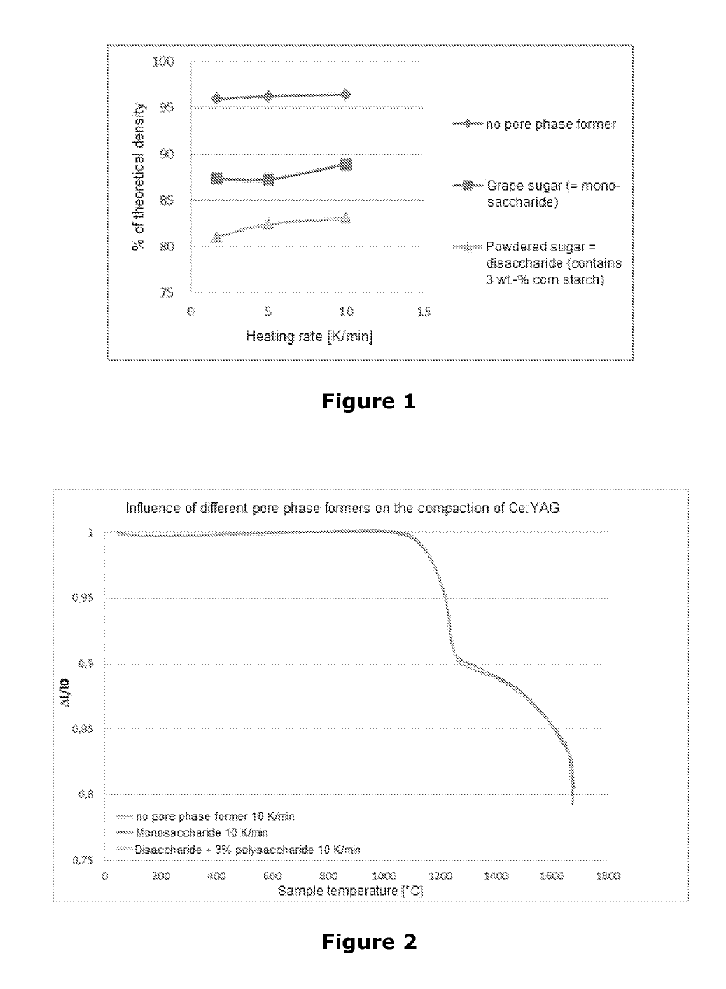

FIG. 1 shows the influence of different pore phase formers as well as the influence of the heating rate on the density of the ceramic. The sintering temperature was the same for all ceramics shown in FIG. 1. Using powdered sugar (disaccharide+3 wt.-% corn starch) as pore phase former, ceramics with lower density have been obtained in comparison to ceramics, for production of which grape sugar (monosaccharide) was used as pore phase former. Furthermore, it is apparent that more dense ceramics are obtained with higher heating rates.

FIG. 2 shows that the sintering behavior of Ce:YAG is not changed by addition of monosaccharide or disaccharide and 3 wt.-% polysaccharide as pore phase formers. Thus, the sintering behavior of the ceramic material itself is not affected by the natural pore phase formers. The heating rate was 10 K/min in each case.

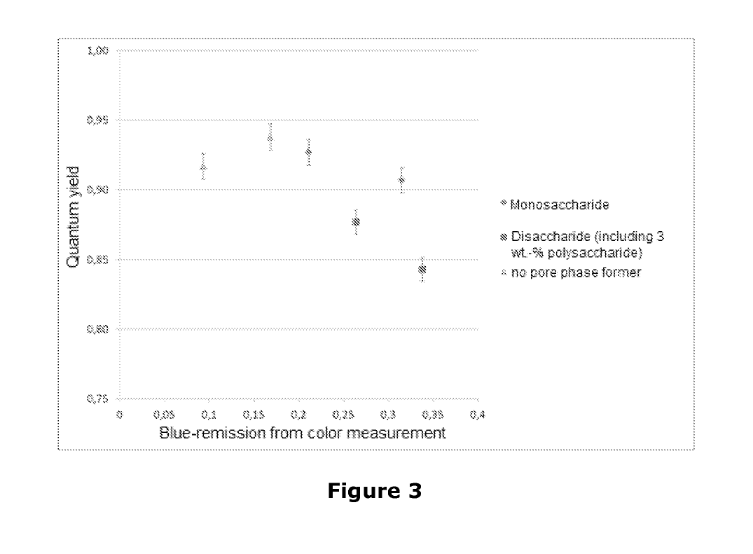

FIG. 3 shows the influence of different pore phase formers on the quantum yield and on the blue-remission. Due to the use of disaccharide and 3 wt.-% polysaccharide as pore phase formers, the quantum yield is reduced in comparison to ceramics, for production of which either no pore phase former was used or monosaccharide was used as pore phase former. Use of monosaccharide as pore phase former does not result in a reduction of quantum yield in comparison to ceramics, for production of which no pore phase former was used. Ceramics, for production of which monosaccharide or disaccharide and 3 wt.-% polysaccharide was used as pore phase former, have an increased blue-remission in comparison to ceramics, for production of which no pore phase former was used.

### EXAMPLE 1

### Preparation of a Translucent Ceramic from Y₃Al₅O₁₂ with 0.05 wt % CeO₂ through Uniaxial Pressing (With Reactive Sintering)

Powders of primary particles having diameters of <1 μm of 2.5 mol of Al₂O₃, 1.4965 mol of Y₂O₃ and 0.0863 mol of CeO₂ are weighed out in the ratio according to the target composition. After the addition of dispersants and binders the mixture is mixed with ethanol and Al₂O₃ balls in a ball mill for 12 to 16 h.

For the milled suspension there is a choice of drying in a rotary evaporator or granulating in a spray dryer.

Subsequently, the powder is uniaxially molded into discs or rods. The uniaxial pressure conditions are 10 MPa and the pressure time is 30 s. The preformed molded body is further compacted in a cold isostatic press, wherein the pressing pressure is 200 MPa for 1 min. The medium for pressure transfer is water.

Subsequently, in a first thermal step binder is burnt out. The tempering time is 6 h and the temperature is 700° C. Subsequently, the burnt out green body is sintered in a chamber kiln under enriched O₂ atmosphere, i.e. an oxygen stream in a normal chamber kiln. The sintering temperatures and times depend on the sintering behavior of the mixture, i.e. after the formation of the composition the further compaction into a ceramic with defined specifically adjusted pores is conducted. In the case of Ce:Y₃Al₅O₁₂ the garnet phase is formed starting at a temperature of ca. 1350 to 1450° C. The sintering into a ceramic body is effected at higher temperatures of between 1650 and 1700° C. for 3 h.

Optically translucent and homogenous bodies are formed which can be processed into converter materials.

### EXAMPLE 2

### Preparation of a Translucent Ceramic from Y₃Al₅O₁₂ with 0.2 wt % CeO₂ through Uniaxial Pressing (With Reactive Sintering)

The method was conducted as in example 1 with the modification that after mixing in the ball mill a second mixing step in an asymmetric moved mixer for 10 to 24 h was conducted. The mixing step in the asymmetric moved mixer increases the homogeneity and so single phase YAG structures with only few non-reacted Al₂O₃ grains are formed.

### EXAMPLE 3

Preparation of a Translucent Ceramic from Y₃Al₅O₁₂ with 0.2 Weight Percent of CeO₂ through Uniaxial Pressing (With Reactive Sintering)

The method was conducted as in example 2, wherein prior to the second mixing step in the asymmetric moved mixer 0.15 wt % of TEOS were added to the mixture as a sintering aid. The TEOS is activated by the addition of water:

Si(OC₂H₅)₄+4H₂O═Si(OH)₄+4C₂H₅OH

Si(OH)₄═Si(OH)₂O+H₂O═SiO₂+H₂O

With the help of SEM it could be seen that the number of pores was reduced due to the use of the sintering aid.

### EXAMPLE 4

### Preparation of a Translucent Ceramic from Y₃Al₅O₁₂ with 0.2 Weight Percent of CeO₂ through Uniaxial Pressing (With Reactive Sintering)

The method was conducted as in example 3 with the modification that 0.3 wt % of TEOS were used.

With the help of SEM it could be seen that the reduction of the number of pores due to the use of a higher amount of the sintering aid was further increased.

### EXAMPLE 5

### Preparation of a Translucent Ceramic from (Y,Gd)₃Al₅O₁₂ with 0.2 Weight Percent of CeO₂ through Uniaxial Pressing (With Reactive Sintering)

The method was conducted as in example 4 with the modification that together with TEOS also 20 vol % of rice starch (based on the mixture) were added.

With the help of SEM it could be seen that with the use of rice starch the pores were homogenously distributed and had an ovoid form.

### EXAMPLE 6

### Preparation of a Translucent Ceramic from Y₃Al₅O₁₂ with 0.2 Weight Percent of CeO₂ through Uniaxial Pressing (With Reactive Sintering)

The method was conducted as in example 5 with the modification that instead of the rice starch 10 vol % of potato starch were used.

With the help of SEM it could be seen that with the use of potato starch the pores were very large and oblong.

### EXAMPLE 7

### Preparation of a Translucent Ceramic from Y₃Al₅O₁₂ with 0.2 Weight Percent of CeO₂ through Uniaxial Pressing (With Reactive Sintering)

The method was conducted as in example 6 with the modification that instead of potato starch 10 vol % of wheat starch were used.

With the help of SEM it could be seen that with the use of wheat starch the pores were oblong and smaller than in case of potato starch. The distribution of the pores was more homogenous than in the case of potato starch.

### EXAMPLE 8

### Preparation of a Translucent Ceramic from Y₃Al₅O₁₂ with 0.2 Weight Percent of CeO₂ through Uniaxial Pressing (With Reactive Sintering)

The method was conducted as in example 5 with the modification that only 10 vol % of rice starch were used.

With the help of SEM it could be seen that with the use of rice starch the pores were homogenously distributed and had an ovoid form.

Embodiment examples. The following table shows details of a few experiments

| | | | | | | | Mixing in | | |
|---|---|---|---|---|---|---|---|---|---|
| | Educt 1 | Educt 2 | Educt 3 | | Mixing in | | asymmetric | | |
| Example | (mol %) | (mol %) | (mol %) | Act. c. (wt %) | ball mill | | moved mixer | Sintering aid | Pore phase former |
| 1 | 37.44 Y₂O₃ | 62.47 Al₂O₃ | | 0.1 wt % CeO₂ | 2 × 16 | h | | 0.6 wt % TEOS | 1 vol % corn |
| | | | | | | | | | starch |
| 2 | 37.44 Y₂O₃ | 62.47 Al₂O₃ | | 0.1 wt % CeO₂ | 2 × 16 | h | | 0.6 wt % TEOS | 0.5 vol % potato |
| | | | | | | | | | starch |
| 3 | 37.38 Y₂O₃ | 62.45 Al₂O₃ | | 0.2 wt % CeO₂ | 2 × 16 | h | | 0.6 wt % TEOS | 2 vol % corn |
| | | | | | | | | | starch |
| 4 | 37.33 Lu₂O₃ | 56.18 Al₂O₃ | 6.24 Ga₂O₃ | 0.2 wt % CeO₂ | 16 | h | 16 h | 0.3 wt % TEOS | 2 vol % corn |
| | | | | | | | | | starch |
| 5 | 37.39 Y₂O₃ | 62.45 Al₂O₃ | | 0.2 wt % CeO₂ | 16 | h | 16 h | 0.3 wt % TEOS | 10 vol % potato |
| | | | | | | | | | starch |
| 6 | 37.39 Y₂O₃ | 62.45 Al₂O₃ | | 0.2 wt % CeO₂ | 16 | h | 16 h | 0.3 wt % TEOS | 10 vol % rice |
| | | | | | | | | | starch |
| 7 | 37.41 Lu₂O₃ | 62.46 Al₂O₃ | | 0.1 wt % CeO₂ | 2 × 16 | h | | 0.3 wt % TEOS | 2 vol % corn |
| | | | | | | | | | starch |
| 8 | 37.41 Lu₂O₃ | 62.46 Al₂O₃ | | 0.1 wt % CeO₂ | 16 | h | 16 h | 0.3 wt % TEOS | 2 vol % rice |
| | | | | | | | | | starch |
| 9 | 35.51 Y₂O₃ | 62.44 Al₂O₃ | 1.87 Gd₂O₃ | 0.1 wt % CeO₂ | 16 | h | 16 h | none | 10 vol % grape |
| | | | | | | | | | sugar |
| 10 | 35.51 Y₂O₃ | 62.44 Al₂O₃ | 1.87 Gd₂O₃ | 0.1 wt % CeO₂ | 16 | h | 16 h | none | 10 vol % |
| | | | | | | | | | powdered sugar |

What is claimed is:

1. A polycrystalline ceramic comprising a polycrystalline optoceramic phase and a pore phase comprising pores.

2. The polycrystalline ceramic according to claim 1, further comprising a remission of at least 70% at a wave length of 600 nm.

3. The polycrystalline ceramic according to claim 2, further comprising a sample thickness of 1 mm.

4. The polycrystalline ceramic according to claim 1, wherein the pores have a shape selected from the group consisting of spherical pores, ovoid pores, oblong pores, and mixtures thereof.

5. The polycrystalline ceramic according to claim 1, wherein the pores have diameters of 0.1 to 100 μm.

6. The polycrystalline ceramic according to claim 1, wherein the pores are homogenously distributed in the polycrystalline optoceramic phase.

7. The polycrystalline ceramic according to claim 1, wherein the polycrystalline optoceramic phase comprises at least one optically active center.

8. The polycrystalline ceramic according to claim 1 prepared in a preparation method in which starting materials were mixed with pore phase formers and the pore phase formers comprise saccharides.

9. The polycrystalline ceramic according to claim 1, wherein the polycrystalline optoceramic phase and a pore phase are configured for use as a converter for light conversion from a first wave length to a second wave length.

10. The polycrystalline ceramic according to claim 9, wherein the converter is an LD converter.

11. A method for the preparation of a polycrystalline ceramic comprising an optoceramic phase and a pore phase, comprising the following steps:
providing a mixture of starting materials of the optoceramic phase,
adding of pore phase formers comprising at least one saccharide to the mixture,
preparing a molded body from the mixture, and
sintering the molded body.

12. The method according to claim 11, wherein the step of adding of pore phase formers further comprises adding a sintering aid to the mixture.

13. The method according to claim 11, wherein the step of adding of pore phase formers comprises adding in the pore phase formers in an amount of at least 1 vol % based on the mixture.
